(19) United States
(12) Patent Application Publication
(10) Pub. No.: US 2013/0133208 A1
(43) Pub. Date: May 30, 2013

(54) Trimmer Head with Improved Trimmer Line Eyelets

(71) Applicant: Shakespeare Company, LLC, Columbia, SC (US)

(72) Inventor: David B. Skinner, Columbia, SC (US)

(73) Assignee: Shakespeare Company, LLC, Columbia, SC (US)

(21) Appl. No.: 13/688,956

(22) Filed: Nov. 29, 2012

Related U.S. Application Data
(60) Provisional application No. 61/564,927, filed on Nov. 30, 2011.

(51) Int. Cl. A01D 34/416

(52) U.S. Cl. CPC A01D 34/4163; A01D 34/4166
USPC 30/347; 29/446

(57) ABSTRACT

A trimmer head for a rotary trimmer machine includes a housing having a recess, a trimmer line spool removably mounted in the recess, at least one exit opening on the housing wherein trimmer line wound on the spool passes through from within the housing, and an eyelet disposed in the exit opening. The eyelet includes an open area leading into a slotted area, said open area being normally closed by a pivoting gate biased into the closed position, and movable to an open position allowing trimmer line to move through the open area past the gate into the slotted area. The trimmer line spool is reversible so that when installed in a first configuration, the trimmer head may be installed on a clockwise rotating trimmer machine, and when the trimmer line spool is installed in a second configuration, the trimmer head may be installed on a counter-clockwise rotating trimmer machine.

### CROSS-REFERENCE TO RELATED APPLICATION

The present application claims priority to U.S. Provisional Patent Application No. 61/564,927 filed Nov. 30, 2011, which is incorporated by reference as if fully rewritten herein.

### FIELD OF THE INVENTION

The present invention generally relates to trimmer heads for rotary trimmer machines using monofilament line as a means for cutting vegetation; and, more specifically to trimmer heads for rotary trimmer machines with carabiner style eyelets for improved loading of monofilament line.

### BACKGROUND OF THE INVENTION

Trimmer heads for rotary trimmer machines are known in the art. These trimmer heads generally carry one or two lengths of monofilament line wrapped about an interior spool with the ends of the line or lines projecting outwardly through opposed eyelets in the side wall of the trimmer head. The trimmer head is threadably mounted on the end of an elongated shaft and rotated at a high velocity by a gas or electric motor so that the ends of the cutting line project radially from the head and sever weeds or other vegetation. The cutting line may be paid out from the spool either manually or automatically as with bump-feed type trimmer heads. In either scenario, eventually the cutting line will be used up and the spool either replaced or replenished. When replacing the spool in the trimmer head, the ends of the cutting line must be threaded through the eyelets on the side wall of the trimmer head. This has often proven to be cumbersome leading to a need for a trimmer head with improved eyelets for loading trimmer line.

### SUMMARY OF THE INVENTION

In an embodiment, there is provided a trimmer head, including a housing having a recess, a trimmer line spool removably mounted in the recess in the housing, at least one exit opening on the housing wherein trimmer line wound on the spool passes through from within the housing, and a normally closed gate adjacent the exit opening, movable to an open position allowing passage of trimmer line from an open area adjacent the exit opening past the gate into a slotted area.

In an embodiment, there is provided an adaptable trimmer head for a rotary trimmer machine, the trimmer head being adaptable for attachment to a clockwise rotating trimmer machine or a counter-clockwise rotating trimmer machine. The trimmer head including a housing having a recess, a reversible trimmer line spool removably mounted in the recess in the housing, a ground contacting member that when depressed into the ground when the trimmer head is rotating causes trimmer line to be dispensed from the trimmer line spool within the housing, wherein the trimmer line spool includes a first side that is attached to the ground contacting member when it is desired to rotate the trimmer head in a counter-clockwise direction and a second opposite side that is attached to the ground contacting member when it is desired to rotate the trimmer head in a clockwise direction, at least two exit openings on the housing wherein trimmer line wound on the spool passes through from within the housing, and a normally closed gate adjacent each exit opening, movable to an open position allowing passage of trimmer line from an open area adjacent the exit opening past the gate into a slotted area.

In an embodiment, there is provided an eyelet for a rotary trimmer head configured to allow trimmer line wound onto a spool disposed in a housing of the trimmer head to pass from within the housing, including a U-shaped frame, a slotted area, an open area leading into the slotted area, and a pivoting gate normally biased into a closed position sealing the open area, and movable to an open position and configured to allow trimmer line to move from said open area past the gate into the slotted area, and then return to the closed position.

In an embodiment, there is provided a method of installing trimmer line in a trimmer head of a rotary trimmer machine, including the steps of providing a housing having a recess, removably mounting a trimmer line spool in the housing, and passing trimmer line wound on the spool from within the housing through at least two eyelets on the housing by performing the steps of: urging free ends of the trimmer line against a pivoting gate normally biased into a closed position to an open position, said pivoting gate normally sealing an open area of the eyelet, moving the free ends of the trimmer line from the open area past the gate into a slotted area, and releasing the gate after the free ends of the trimmer line are disposed in the slotted area to allow it to return to the normal closed position.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a prior art trimmer head with conventional trimmer line eyelets;

FIG. 2 is an embodiment of a trimmer head with carabiner style trimmer line eyelets;

FIG. 3 is a side view of the trimmer head of FIG. 2;

FIG. 4 is a partially exploded perspective view of the trimmer head of FIG. 2;

FIG. 5 is an exploded perspective view of the trimmer head of FIG. 2;

FIG. 6 is a perspective sectional view of the trimmer head of FIG. 2;

FIG. 7 is a spool assembly for the trimmer head of FIG. 2;

FIG. 8 is a perspective sectional view of an indexing mechanism for use with the trimmer head of FIG. 2;

FIG. 9 is a top view of the indexing mechanism shown in FIG. 8;

FIG. 10 is an exploded view of the indexing mechanism shown in FIG. 8;

FIG. 11 is a front view of an embodiment of a carabiner style trimmer line eyelet for use with the trimmer head of FIG. 2; and

FIG. 12 is a rear view of an embodiment of a carabiner style trimmer line eyelet for use with the trimmer head of FIG. 2.

### DETAILED DESCRIPTION OF THE INVENTION

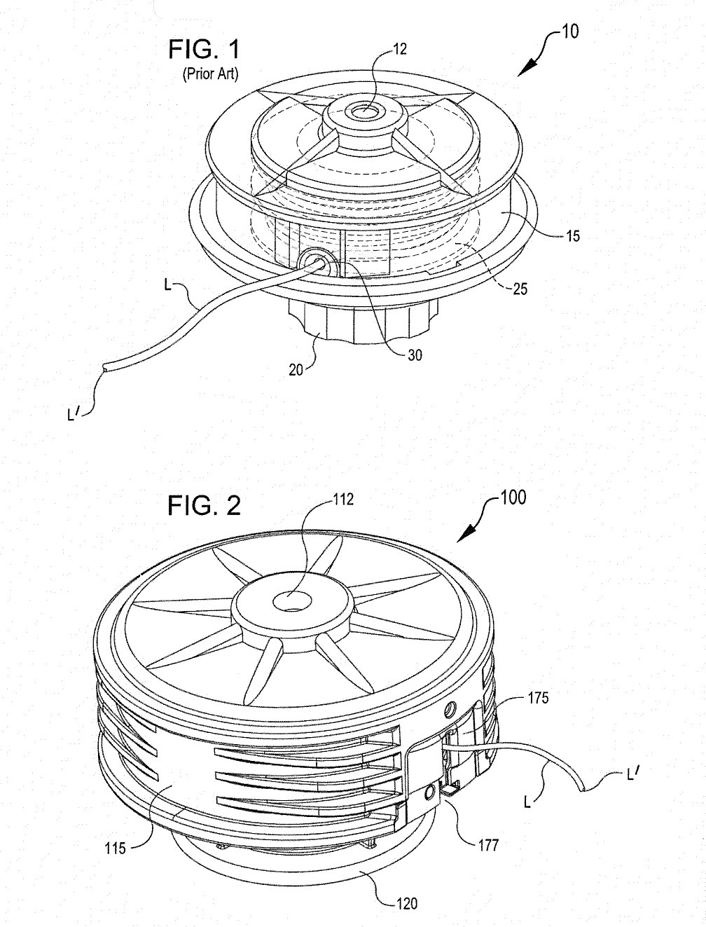

Referring now to the drawing figures in which like reference designators refer to like elements, there is illustrated in FIG. 1 a prior art trimmer head 10 having opposing conventional eyelets 30 configured to allow monofilament line L wound onto an internal spool 25 to exit from within the trimmer head housing 15. The trimmer head 10 of the prior art is designed to be mounted on the extended end of a rotatable drive shaft (not shown) on a gasoline or electric powered rotary trimmer (not shown). A central threaded aperture 12 in the trimmer head housing 15 is provided for mounting the trimmer head 10 on the end of the rotatable drive shaft (not shown). The eyelets 30 may be received into slots formed in the trimmer head housing 15 in a press fitment. The eyelets 30 may be made of any material including plastic or metal and are formed with a central aperture for allowing the monofilament line L to pass there through. After the monofilament line L is wound by hand onto the spool 25, the ends L′ of the monofilament line L are inserted into the eyelets 30 prior to the spool 25 being inserted into the trimmer head housing 15. As the spool 25 is inserted into the trimmer head housing 15, the monofilament line L is pulled through the eyelets 30 to take up any slack in the monofilament line L until the spool 25 is fully seated into the trimmer head housing 15. A cap 20 may then be installed onto the trimmer head housing 15 to secure the spool 25 therein.

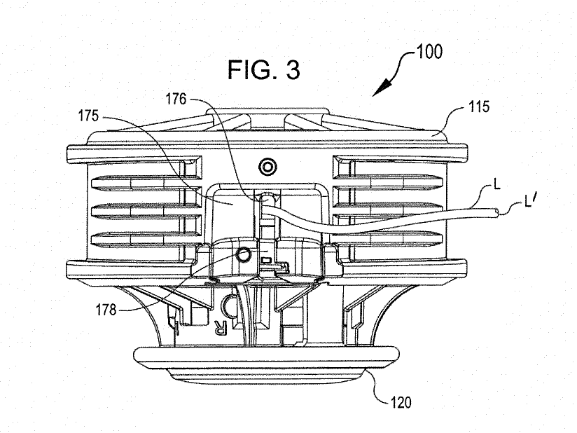

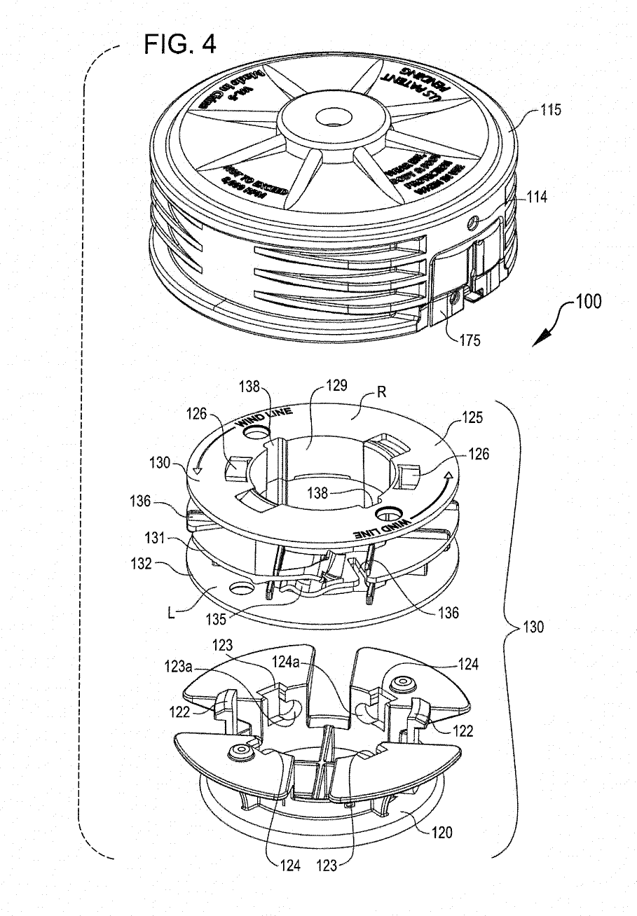

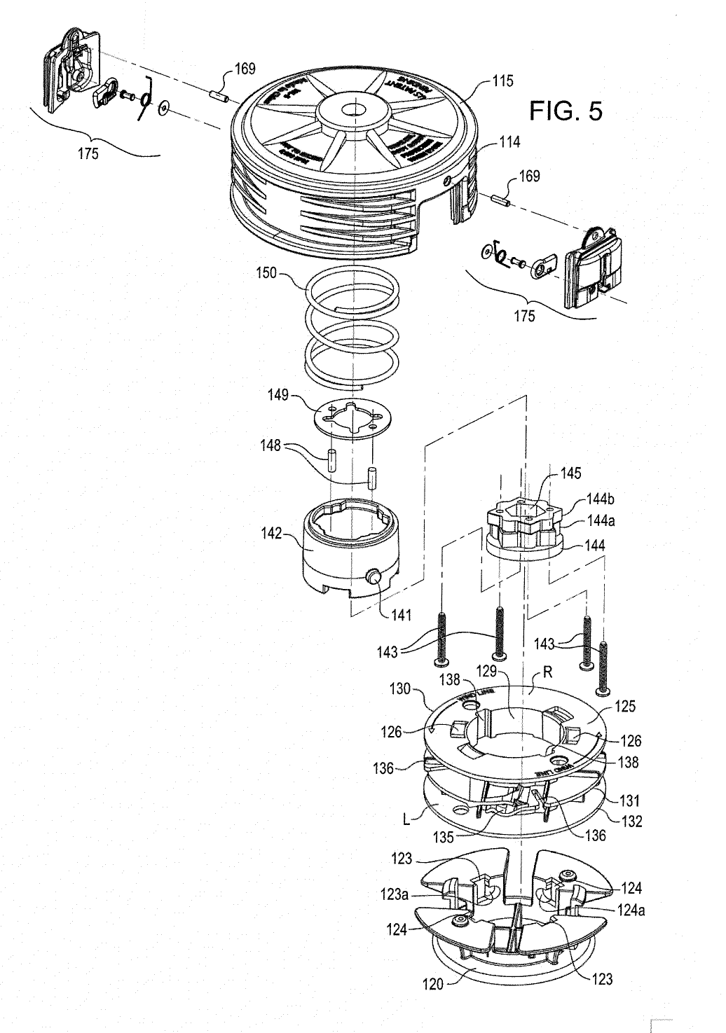

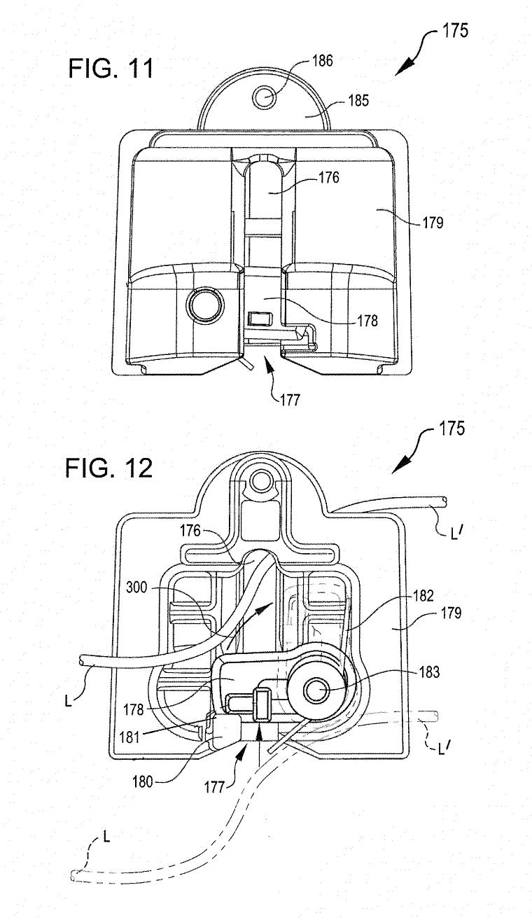

Referring now to FIGS. 2 and 3, there is illustrated an exemplary embodiment of a bump-feed type trimmer head 100 having a pair of opposing carabiner style eyelets 175 (best seen in FIG. 5) for improved installation of the monofilament line L as the trimmer line spool assembly 125 (FIG. 4) is installed into the trimmer head housing assembly 115. The use of the carabineer style eyelets 175, 175 eliminates the need to thread the ends L′ of the section of trimmer line L on the spool 125 into prior art eyelets 20 prior to installing the spool 125 into the housing assembly 115. Instead, the free ends L′ of the section of trimmer line L are pushed through an open area 177 (see also FIGS. 11 and 12) in each of the eyelets 175 and past a spring-loaded gate 178 into a slotted area 176 of the eyelet 175. In addition to the housing assembly 115 and the spool assembly 125, the trimmer head 100 may include a bump knob assembly 120 which is installed on the bottom of the housing assembly 115 as described in detail herein below.

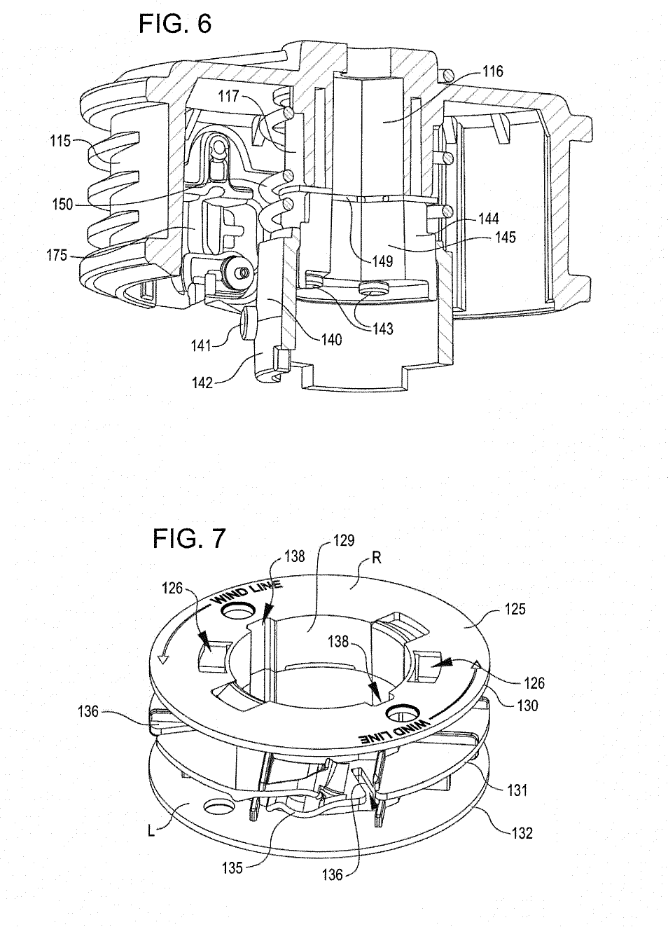

In an embodiment, an adapter kit (not shown) may be provided to install the trimmer head 100 on a trimmer machine (not shown) including fifteen or so nuts and bolts, and a few spacers packaged in a plastic bag. The first step for installing the trimmer head 100 on a trimmer machine would be to select a nut or bolt which mates with the corresponding threads on the shaft of the trimmer machine. Once the correct fastener is selected, the trimmer shaft is inserted into an aperture 112 in the trimmer head 115 and the fastener (not shown) placed in the hexagon passage 116 (FIG. 6) of the housing assembly 115. By spinning the housing assembly 115 relative to the threads on the shaft of a trimmer machine, the threads from the fastener (not shown) mate with the threads on the shaft of the trimmer machine. Sometimes spacers are required, but details regarding the use of spacers are known to one of ordinary skill in the art.

Referring now to FIG. 4, the next step for the consumer is to attach the spool assembly 125 to the bump knob assembly 120. If the consumer's trimmer machine was the type to rotate the trimmer head 100 counter-clockwise, then a first side L of the spool assembly 125 would mate with the resilient tabs 122, 122 extending from the bump knob assembly 120. These two resilient tabs 122, 122 would be inserted into complementary slots 126, 126 (not shown) formed in the first side L of the spool assembly 125. Conversely, if the trimmer machine had clockwise rotation of the trimmer head 100, then a second side R of the spool assembly 125 would mate with the same resilient tabs 122, 122 on the bump knob assembly 120. In this scenario, the resilient tabs 122, 122 would be inserted into a pair of complementary slots 126, 126 formed in the second side R of the spool assembly 125. Once the spool assembly 125 is mounted to the bump knob assembly 120, a composite spool and bump knob assembly 130 is formed.

The above instructions for proper assembly of the bump knob assembly 120 to the spool assembly 125, which are independent of one knowing the rotational direction of the trimmer, are rather complicated to communicate to a consumer. At one time, all straight shaft trimmers rotated counter-clockwise and all curved shaft trimmer rotated clockwise. This made it easier to provide installation instructions. However, this is no longer true. Some straight shaft trimmers now also rotate clockwise. Because of this confusion, it has been difficult for manufacturers of bump-activated trimmer heads to communicate to the consumer in simple instructions the proper way to configure the components (spool and line winding direction) of bump-activated trimmer heads for each individual consumer's trimmer machine.

To solve this problem, there is one fact upon which a solution can be designed. All trimmer machines which rotate the trimmer head 100 counter-clockwise require left-handed threads if the trimmer head 100 is to stay on the trimmer machine during use. The trimmer head 100 will unscrew itself from a counter-clockwise rotating trimmer machine if right-handed threads are used. Likewise, all trimmer machines, whether straight shaft or curved shaft, will require right-handed threads to keep the trimmer head 100 attached if the trimmer machine rotates the trimmer head 100 clockwise.

To solve the communication problem with consumers, the nuts and bolts provided with the subject trimmer head 100 may be pre-colored either black or yellowish-gold. The spool assembly 125 is also two colored: one part black and one part yellow/gold. The right-handed nuts and bolts supplied with the subject trimmer head 100 are colored black, and the nuts and bolts with left-handed threads are colored yellowish gold. The two-colored spool assembly 125 has been designed such that if a black nut or bolt is used (right-handed threads) for clockwise rotation of the trimmer head 100, then the black portion or first side L of the spool assembly 125 is to be connected to the bump knob assembly 120. Conversely, if the consumer uses a yellowish-gold fastener (left handed threads), then the yellow portion or second side R of the spool assembly 125 is attached to the bump knob assembly 120. In other words, by color coding both the fasteners and the spool assembly 125, this combination of indicia based upon color provides a solution to a problem that has long frustrated manufacturers of bump-activated trimmer heads.

It is significant to note that the consumer only needs to perform the steps of assembling the bump knob assembly 120 to the spool assembly 125 once. Once the spool assembly 125 and bump knob assembly 120 have been combined for a given trimmer machine, there is no need to disconnect these two components. However, because the two components are reversibly connected, the consumer could later disconnect and reconnect the two components for a trimmer machine that operates in the opposite direction of rotation. The consumer could also replace the bump knob assembly 120 without having to replace the spool assembly 125, or vice versa. This is one of the advantages of this trimmer head 100 arrangement. The trimmer head 100 is not only universally adaptable to any trimmer machine, but with the use of color indicia, any consumer can easily configure the trimmer head 100 for any trimmer machine.

The final step for the consumer to install the trimmer head 100 on a trimmer machine would be to wind the monofilament line L onto the spool assembly 125, tuck the ends into clips 135, 135 on the spool assembly 125 which hold the monofilament line L in place, and then press the ends L′ of the monofilament line L into the eyelets 175, 175. The spool and bump knob assembly 130 is then slid onto an indexing mechanism 140 (see FIG. 6) disposed in the housing assembly 115 and secured thereon with a twisting and locking motion. After a light tug on the two ends L′ of the monofilament line L, the consumer is ready to begin to use the trimmer head 100.

The foregoing arrangement will allow a pair of projections 141, 141 on the indexing mechanism 140 (FIGS. 5 and 6) to slide within the length of a pair of complementary slots 138, 138 formed in the spool assembly 125, and further into a pair of complementary slots 123, 123 formed in the bump knob 120. The slots 123, 123 have a “L” shape orientation such that the projections 141, 141 on the indexing mechanism can lock into adjacent recesses or sockets 123a, 123a when the spool and bump knob assembly 130 are rotated relative to the housing 115 and indexing mechanism 140 in the twisting and locking motion.

Another aspect of this invention is that once the consumer connects the spool assembly 125 to the bump knob assembly 120, the consumer will only see one arrow on the exposed or non-attached side of the spool assembly 125, which instructs the consumer as to the direction to wind the monofilament line L onto the spool assembly 125. Many bump-activated trimmer heads in the prior art have two arrows on the spool assembly. One arrow indicates the direction to wind the line for left-hand rotating trimmers (counter-clockwise when viewed from above), and a second arrow in the opposite direction from the first, which indicates the direction to wind the line for right-handed rotation (clockwise if viewed from above). One aspect adding confusion for consumers is that the direction of rotation is reversed if viewed from above versus view from below. The arrows added to heads in the prior art were pointed based upon the direction of rotation being determined if viewed from above. However, the direction of rotation is reversed if viewed from the bottom side of the trimmer head 100. And, the consumer is typically viewing the trimmer head 100 upside down when installing the monofilament line L. This level of confusion can cause a consumer to give up on using the trimmer heads described in the prior art. However, with the subject trimmer head 100 and the combination of color indicia, the consumer no longer has to remember whether the trimmer machine rotates the trimmer head 100 clockwise or counter-clockwise; the consumer does not have to select between two arrows to get the correct direction for winding the monofilament line L. Only one arrow is visible once the spool assembly 125 is attached to the bump knob assembly 120.

To wind the line L on the spool assembly 125, the consumer would obtain a 10 to 20 foot long piece of monofilament line L. Ideally the length of monofilament line L would be the longest length that would fit onto the spool assembly 125 within the volume defined by the outer flanges 130, 132 and the inner flange 131, their perimeter and the inside wall of the spool assembly 125. The center point of the monofilament line L would be placed in one of the slits 136 formed in the inner flange 131 of the spool assembly 125. The inner flange 131 has four slits 136 equally spaced along its perimeter.

Next, the two ends L′ of the monofilament line L should be wrapped in the direction of the arrow shown on the outer flange (either 130 or 132) of the spool assembly 125. One end L′ of monofilament line L would be wound into each segment of the spool assembly 125 and both portions in the same direction as the one arrow. When all of the monofilament line L is wrapped onto the spool assembly 125, then the free ends L′ of the line L can be pressed into the two clips 135, 135 located on the perimeter of the inner flange 131. The purpose of the two clips 135, 135 are to hold the monofilament line L while proceeding with the following steps. The use of the clips 135, 135 provides significant convenience to the consumer.

The clips 135, 135 are on opposite sides of the spool assembly 125 one hundred eighty (180°) degrees apart. There should be about 6 to 8 inches of monofilament line L extend from the spool and bump knob assembly 130. The free ends L′ of the monofilament line L may easily be pressed into the carabiner style eyelets 175, 175 as the spool and bump knob assembly 130 is assembled to the housing assembly 115. As the spool and bump knob assembly 130 is assembled to the housing assembly 115, the two projections 141, 141 on the indexing mechanism 140 slide into the pair of slots 138, 138 positioned along the inner sidewall of a central aperture 129 formed in the spool assembly 125 and the pair of slots 123, 123 fowled on the interior of the bump knob assembly 120. When the projections 141, 141 reach the bottom of the slots 138, 138 and 123, 123, then the user would twist the bump knob assembly 120 to force the projections 141, 141 into the sockets 123a, 123a formed adjacent to the slots 123, 123. Or, the consumer can simply pull on the two ends L′ of the monofilament line L, which will also force the projections 140, 140 into the sockets 123a, 123a.

One of the common challenges with replacing the monofilament line L in a bump head type trimmer head is the challenge of winding the monofilament line L on the spool assembly and then placing that spool assembly back into the trimmer head; it requires some dexterity. Some manufacturers of trimmer machines have changed the bump head design to a quick loading type to make monofilament line L loading easier. In these cases, the monofilament line L is threaded through one eyelet of the trimmer head, through a channel on the spool assembly, and then out the other eyelet. Next, a knob or a portion of the trimmer head is turned which pulls the monofilament trimmer line L into the trimmer head as the monofilament line L is wrapped onto the spool assembly.

There are several short comings with these “easy line loading” heads. First, because the monofilament line L is not wound tightly and because the monofilament line L is not wound in neat adjacent wraps, there can be a tendency for the monofilament line L to tangle and weld inside the trimmer head during use. Manufacturers of these “easy line loading” trimmer heads have solved this issue by limiting the length of monofilament line L wound into the trimmer head; typically less than ten (10) feet of monofilament line L can be used if one wants to avoid these tangling and welding problems. However, this shortening of the monofilament line L length is counter to one of the advantages of the bump feed heads. Commercial landscapers like the longer length of monofilament line L in the trimmer head to minimize the need to stop and replace the monofilament line L.

Another shortcoming with the “easy line loading” trimmer heads is that it is difficult to thread the monofilament line L through the pathway provided. There are gaps between the inside of the eyelets and the monofilament line L channel passing through the spool assembly. Unless the consumer understands these shortcomings, there is a good chance that he or she will push the monofilament line L through the first eyelet but the tip of the monofilament line L will miss the entrance to the line channel. The monofilament line L will go into the volume of the trimmer head but the end will not exit the second eyelet. The user has to pull the monofilament line L out and try again.

Another problem with these trimmer heads is that the ramps used to control the direction of rotation so that the monofilament line L is wound in the correct direction also prevents the trimmer head for being used for both clockwise and counter-clockwise rotating trimmer machines.

Another solution to the problem of replacing the monofilament line L in a bump head has been for the manufacturer or retailer to sell pre-wound replacement spools. However, because some trimmer machines rotate clockwise and others counter-clockwise, the retailer has to offer at least two SKU's for each trimmer head; one replacement spool with monofilament line L wound clockwise and another with monofilament line L wound counter-clockwise. The two-piece spool assembly 125 overcomes the above deficiency and makes the spool assembly 125 suitable as a universal replacement SKU (one SKU) for the trimmer head 100, regardless of whether the trimmer head 100 is attached to a trimmer machine that rotates clockwise or counter-clockwise. Either side of the spool assembly 125 may be reversibly attached to the bump knob assembly 120. Attaching one side of the spool assembly 125 to the bump knob assembly 120 allows it to be used with clockwise rotating trimmer machines. Attaching the opposite side of the spool assembly 125 to the bump knob assembly 120 allows it to be used with counter-clockwise rotating trimmer machines.

Obviously, other color combinations may be used other than yellow and black. However, the uniqueness of indicia stems from color coding both the spool assembly 125 and the fasteners, and doing so in a manner that simplifies the configuration of the trimmer head 100 for clockwise or counter-clockwise rotation.

Referring now to FIGS. 5 to 10, four screws 143 are used to affix the indexing mechanism 140 to the housing assembly 115. The indexing mechanism 140 selectively allows relative movement of the spool assembly 125 with respect to the housing 115 in response to bumping of the bump knob assembly 120 of the trimmer head 100 on the ground to pay out measured lengths of monofilament line L. The simplified pay-out indexing mechanism 140 includes a spring-loaded cam 144 and cam follower 142 arrangement. The cam 144 includes a central bore 145 having a hexagonal cross-section. This hexagonally shaped bore 145 abuts the hexagonally shaped cross-section of the passage 116 formed in housing assembly 115 such that the trimmer head 100 may be attached to the trimmer shaft using a variety of supplied fasteners. With the present invention, the consumer does not need to disassemble the indexing mechanism 140 from the housing assembly 115 to change the fasteners. The fact that the housing assembly 115 in the present invention is readily adaptable to a wide variety of trimmer machines without disassembling the line indexing mechanism 140 is heretofore unknown for bump heads that utilize an indexing mechanism 140 for indexing the payout of monofilament line L.

Referring back also to FIG. 4, at the inside lower surface of the bump knob assembly 120 are two of the sockets 123a and 124a adjacent their respective slot 123 and 124. The bump knob assembly 120 also includes two additional sockets 123a, 124a, which are each opposite one-hundred eight degrees (180°) apart the corresponding sockets 123a, 124a. All four of the sockets 123a, 123a, 124a and 124a are adjacent a corresponding slot 123, 124. The purpose of the two pairs of sockets 123a, 124a is that one of these pairs of sockets will be used to lock the two projections 141, 141 extending from the cam follower 142. The projections 141, 141 snap into the sockets 123a or 124a depending on which side of the spool assembly 125 is attached to the bump knob assembly 120. This depends on the desired direction of rotation of the trimmer head 100, i.e., clockwise or counter-clockwise. The snapping of the projections 141, 141 into one of the pairs of sockets 123a, 123a or 124a, 124a affixes the spool and bump knob assembly 130 to the cam follower 142.

The axial slots 138, 138 on the inside of the spool assembly 125 will align with two of the respective slots 123, 123 or 124, 124 associated with the sockets 123a, 123a or 124a or 124a, such that the projections 141, 141 on the cam follower 142 may only interface with the corresponding sockets 123a, 123a or 124a, 124a. For example, if the trimmer head 100 rotates clockwise, then the side R of the spool assembly 125 will be mated with the bump knob assembly 120. This is the first or black side of the spool assembly 125. This will cause the slots 138, 138 to align with the two sockets 124a, 124a. As the trimmer head 100 rotates clockwise (when looking from above), any bumping action will create resistance to the rotation of the trimmer head 100, and the forces generated will keep the projections 141, 141 on the cam follower 142 pressed into the sockets 124a, 124a.

Oppositely, if the trimmer head 100 rotates counter-clockwise, then the second side or side L of the spool assembly 125 will be mated with the bump knob assembly 120. This is the yellow/gold side of the spool assembly 125. This will cause the slots 138, 138 of the spool assembly 125 to align with the two sockets 123a, 123a. Again, bumping the bump knob assembly 120 of the trimmer head 100 on the ground will create resistance to the direction of rotation of the trimmer head 100, and the forces generated will keep the projections 141, 141 on the cam follower 142 seated in the sockets 123a, 123a.

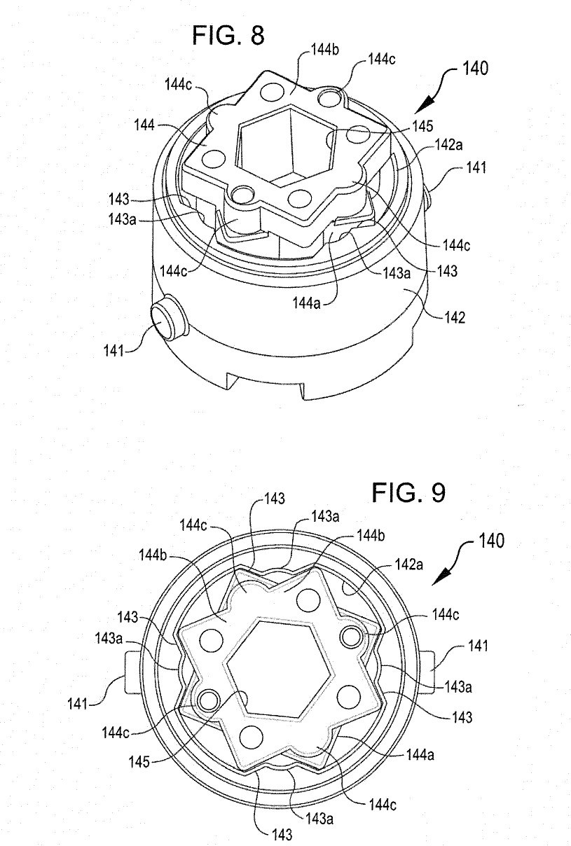

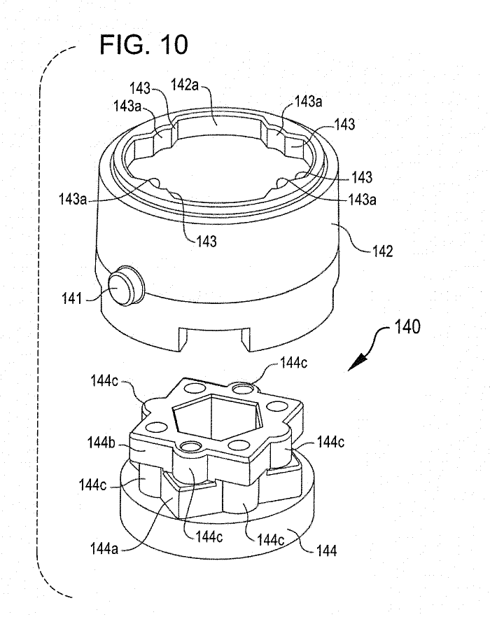

As previously described, the simplified pay-out indexing mechanism 140 includes the spring-loaded cam 144 and the cam follower 142. The cam follower 142 has an internal shape 142a as shown in FIG. 8-10. The cam 144 has an outer shape as best seen in FIGS. 8 and 10. The cam 144 includes two generally square layers 144a, 144b and each layer 144a, 144b includes a rounded arch 144c on each of the sides of the square, the arch 144c being disposed at the midpoint between the corners of the squares 144a, 144b.

The internal shape 142a of the cam follower 142 has been designed to work with the square layers 144a, 144b of the cam 144. The internal shape 142a of the cam follower 142 includes four projections 143 spaced evenly ninety-degrees (90°) apart. The projections 143 have a radius of material 143a removed to allow for the arch 144c disposed at the midpoint of the sides of the cam 144 as the cam 144 is rotated.

FIG. 6 in particular illustrates the trimmer head 100 with the indexing mechanism 140 in place. The housing assembly 115 includes a cylindrical section 117 with a hexagonal channel 116 disposed in this cylinder section 117. A spring 150 is placed over the cylindrical section 117. Next, the cam washer 149 is placed against the cylindrical section 117 using metal pins 148, 148 pressed into apertures formed in the cylindrical section 117 for alignment. The cam follower 142 and the cam 144 are then placed against cam washer 149. While keeping the spring 150 under compression, the four screws 143 are added which connect the cam 144 to the cylindrical section 117 of the housing 115. The spring 150 may now be released. The spring 150 is constantly providing a bias to keep the cam follower 142 urged away from the housing 115. The proper connection of these components will leave a hexagonal cavity 116, 145 down the middle of the housing 115 and cam 144.

When the assembled rotating trimmer head 100 is bumped on the ground during use, the bumping action will created an upward movement of the spool and bump knob assembly 130. Because the cam follower 142 is connected to the spool and bump knob assembly 130, it too is pushed upward against the spring 150. When this happens, the projections 143 on the cam follower 142 can move from a position of rest associated with a first square layer 144a to an adjoining second square layer 144b staggered forty-five (45°) degrees and stacked on top of the first square layer 144a. The cam follower 140 and the spool assembly 125 which are connected will rotate approximately forty-five (45°) degrees relative to the housing assembly 115. Then the projections 143 on the cam follower 142 will be pressed by the spring 150 back to the first square layer 144a where the cam follower 140 and the spool assembly 125 will again rotate approximately forty-five (45°) degrees relative to the housing assembly 115 before coming to a position of rest. These two forty-five (45°) degree rotations will allow a fixed length of monofilament line L to be released through the eyelets 175, 175 of the trimmer head 100 by centrifugal action, lengthening the monofilament line L extending from the trimmer head 100. Changing the shape of the cam 144 along with the internal shape 142a of the cam follower 142 will change the amount of monofilament line L released.

The bumping action can be repeated to release the monofilament line L stored on the spool assembly 125 until there is no monofilament line L left to release.

Referring now to FIGS. 11 and 12, the eyelet 175 is illustrated which functions in much the same way as a mounting climbing carabiner loop having a sprung gate. There is a latch 178 pivotally attached via a pin 183 to the inside of one side of the “U” shaped or horseshoe shaped frames 179. Additionally, the latch 178 is biased so that in the biased position, it traverses an open area 177 of the “U” shaped frame 179. When a length of monofilament line L is moved in the direction of the open area 177 and urged against the bottom of the latch 178, the consumer can easily press the monofilament line L through the open area 177 of the “U” shaped frame 179 into a slotted area 176. The latch 178 is designed to pivot out of the way in the direction of arrow 300 as the monofilament line passes through the open area 177. The latch 178 is designed so that once the monofilament line L reaches the slotted area 176, then the monofilament line L is no longer pressing on the latch 178 and the latch 178 can return to its biased position. The monofilament line L is at this point captured in the slotted area 176 of the eyelet 175 and is surrounded on all sides by the eyelet 175. The monofilament line L cannot be removed radially from the eyelet 175 without manually pressing the latch 178 against the biasing means 182. However, the monofilament line L can travel axially through the slotted area 176 in the eyelet 175. The latch 178 is held at a fixed position against a stop or surface 180 using a spring 182 or other biasing means. Optionally, the stop or surface 180 may include a secondary flange, lip or surface 181 on the upper portion of the primary stop 180. The purpose of this flange 181 is to minimize radial movement by the latch 178 relative to the axis of rotation of the trimmer head 116.

The perimeter of the eyelet 175 contains a flange 185 that mates with a cutout on the housing 115. The flange 185 of the eyelet 175 may include hole 186 that may be aligned with a hole 114 in the housing 115. A pin 169 (see FIG. 5) may be pressed into the two aligned holes 114 (FIGS. 5) and 186 to prevent the removal of the eyelet 175 from the housing 115. The eyelet 175 is preferably comprised of aluminum but any material known to one of ordinary skill in the art may be used.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A trimmer head, comprising:
a housing having a recess;
a trimmer line spool removably mounted in the recess in the housing;
at least one exit opening on the housing wherein trimmer line wound on the spool passes through from within the housing; and
a normally closed gate adjacent the exit opening, movable to an open position allowing passage of trimmer line from an open area adjacent the exit opening past said gate into a slotted area.

2. The trimmer head of claim 1, further including a ground contacting member that when depressed into the ground when the trimmer head is rotating causes trimmer line to be dispensed from the trimmer line spool within the housing.

3. The trimmer head of claim 2, wherein the trimmer line spool is mounted to the ground contacting member and the trimmer line spool is mounted in the recess in the housing.

4. The trimmer head of claim 3, wherein the trimmer line spool is a reversible spool and includes a first side that is attached to the ground contacting member when it is desired to rotate the trimmer head in a first direction of rotation and a second opposite side that is attached to the ground contacting member when it is desired to rotate the trimmer head in a second opposite direction of rotation.

5. The trimmer head of claim 4, wherein the first side of the trimmer line spool is marked with a first indicia to indicate a first desired direction of rotation and the second side of the trimmer line spool is marked with a second different indicia to indicate a second opposite direction of rotation when the trimmer line spool is mounted to the ground contacting member.

6. The trimmer head of claim 5, wherein the first indicia is the first side of the spool being a first color and the second indicia is the second side of the spool being a second different and distinct color.

7. The trimmer head of claim 6, further including a first fastener of a first color configured to fasten the trimmer head to a rotary shaft of a trimmer machine when the first side of the spool is attached to the ground contacting member, and a second fastener of a second different color configured to fasten the trimmer head to the rotary shaft of the trimmer machine when the second side of the spool is attached to the ground contacting member.

8. The trimmer head of claim 1, further including an indexing mechanism mounted to the housing in the recess, wherein the trimmer line spool is mounted to the indexing mechanism to mount the trimmer line spool to the housing.

9. The trimmer head of claim 8, further including a ground contacting member that when depressed into the ground when the trimmer head is rotating causes trimmer line to be dispensed from the trimmer line spool within the housing.

10. The trimmer head of claim 9, wherein the trimmer line spool is mounted to the ground contacting member and the trimmer line spool is mounted to the indexing mechanism such that when the ground contacting member is depressed into the ground the indexing member is depressed which further causes trimmer line to be dispensed from the trimmer line spool in a pre-determined amount.

11. An adaptable trimmer head for a rotary trimmer machine, said trimmer head being adaptable for attachment to a clockwise rotating trimmer machine or a counter-clockwise rotating trimmer machine, comprising:
a housing having a recess;
a reversible trimmer line spool removably mounted in the recess in the housing;
a ground contacting member that when depressed into the ground when the trimmer head is rotating causes trimmer line to be dispensed from the trimmer line spool within the housing; wherein the trimmer line spool includes a first side that is attached to the ground contacting member when it is desired to rotate the trimmer head in a counter-clockwise direction and a second opposite side that is attached to the ground contacting member when it is desired to rotate the trimmer head in a clockwise direction;
at least two exit openings on the housing wherein trimmer line wound on the spool passes through from within the housing; and
a normally closed gate adjacent each exit opening, movable to an open position allowing passage of trimmer line from an open area adjacent the exit opening past said gate into a slotted area.

12. The trimmer head of claim 11, wherein the first side of the trimmer line spool is marked with a first indicia to indicate the counter-clockwise direction of rotation and the second side of the trimmer line spool is marked with a second different indicia to indicate the clockwise direction of rotation when the trimmer line spool is mounted to the ground contacting member.

13. The trimmer head of claim 12, wherein the first indicia is the first side of the spool being a first color and the second indicia is the second side of the spool being a second different and distinct color.

14. The trimmer head of claim 13, further including a first fastener of a first color configured to fasten the trimmer head to a rotary shaft of a trimmer machine when the first side of the spool is attached to the ground contacting member, and a second fastener of a second different color configured to fasten the trimmer head to the rotary shaft of the trimmer machine when the second side of the spool is attached to the ground contacting member.

15. The trimmer head of claim 11, further including an indexing mechanism mounted to the housing in the recess, wherein the trimmer line spool is mounted to the indexing mechanism to mount the trimmer line spool to the housing.

16. The trimmer head of claim 15, wherein the trimmer line spool is mounted to the ground contacting member and the trimmer line spool is mounted to the indexing mechanism such that when the ground contacting member is depressed into the ground the indexing member is depressed which further causes trimmer line to be dispensed from the trimmer line spool in a pre-determined amount.

17. An eyelet for a rotary trimmer head configured to allow trimmer line wound onto a spool disposed in a housing of the trimmer head to pass from within the housing, comprising:
a U-shaped frame;
a slotted area;
an open area leading into the slotted area; and
a pivoting gate normally biased into a closed position sealing the open area, and movable to an open position and configured to allow trimmer line to move from said open area past said gate into said slotted area, and then return to said closed position.

18. The eyelet of claim 17, further including a biasing means biasing the gate into the closed position.

19. The eyelet of claim 18, wherein the biasing means is a spring.

20. The eyelet of claim 17, further including an attachment means for attaching the eyelet to the housing of the trimmer head.

21. A method of installing trimmer line in a trimmer head of a rotary trimmer machine, comprising the steps of:
providing a housing having a recess;
removably mounting a trimmer line spool in the housing; and
passing trimmer line wound on the spool from within the housing through at least two eyelets on the housing by performing the steps of:
urging free ends of the trimmer line against a pivoting gate normally biased into a closed position to an open position, said pivoting gate normally sealing an open area of the eyelet;
moving the free ends of the trimmer line from the open area past the gate into a slotted area; and
releasing the gate after the free ends of the trimmer line are disposed in the slotted area to allow it to return to the normal closed position.
